(19) United States
(12) Patent Application Publication
(10) Pub. No.: US 2026/0216769 A1
(43) Pub. Date: Jul. 30, 2026

(54) PROCESS FOR TREATING CALCIUM-SILICA-BASED INDUSTRIAL SOLID WASTE

(71) Applicant: THE HONG KONG POLYTECHNIC UNIVERSITY, Hong Kong (CN)

(72) Inventors: Shipeng ZHANG, Hong Kong (CN); Hanxiong LYU, Hong Kong (CN); Chi sun POON, Hong Kong (CN); Zhenlin LI, Hong Kong (CN)

(21) Appl. No.: 19/037,386

(22) Filed: Jan. 27, 2025

(51) Int. Cl. B09B 3/70; C22B 3/44; C25C 1/02

(52) U.S. Cl. CPC B09B 3/70; C22B 3/44; C25C 1/02

(57) ABSTRACT

A process for treating calcium-silica-based industrial solid waste comprising: combining the solid waste with an aqueous solution comprising a metal chelating agent and water thereby forming a solid waste suspension; combining the solid waste suspension with an acid precursor thereby forming an electrolysis mixture; subjecting the electrolysis mixture to electrolysis whereby the acid precursor is oxidized in situ thereby forming an acid and at least a portion of metal ions in the solid waste are extracted into the water thereby forming a first mixture comprising a metal solution, comprising the at least a portion of metal ions and water, and a first residue; separating the metal solution and the first residue; and combining the metal solution with a solution comprising a first precipitator and optionally a surfactant thereby forming a suspension comprising metal. The process can recycle the solid waste in an efficient and eco-friendly manner.

### TECHNICAL FIELD

The present disclosure relates to a process for treating calcium-silica-based industrial solid waste, such as concrete waste, incineration bottom ash, incineration fly ash, coal fly ash, steel slag and waste glass.

### BACKGROUND

Increasing generation of industrial solid waste, in particular those based on calcium and silica, is a matter of global concern. The implications of different industrial solid waste on the environment and human health have become more critical over recent years. Potential leaching and accumulation of toxic contaminants from the industrial solid waste into the environmental matrices concomitantly affect human health and other living organisms. Recycling the industrial solid waste back into construction or other industry offers a vital solution.

Taking concrete waste for example, the components contained therein can be broadly categorized into spent aggregates and hydrated cement paste, and theoretically, can be reutilized in concrete production if separated. Recycled aggregate from straightforward crushing of the used concrete cannot substitute natural aggregates due to residual cement pastes that compromise new concrete's strength and durability. Alternative methods like acid impregnation, microwave removal, and carbonation treatment aim to either remove paste residues or enhance the bulk properties, but face practical constraints, such as environmental and safety concerns, technical complexity, cost, and scalability issues.

Additionally, effective recycling of hydrated cement paste, the most valuable component of concrete waste, remains elusive. Direct clinker resurrection using concrete waste is hindered by the impurities brought in smaller particles of fine aggregate, and also contaminants in waste like sulfates and chloride, which can alter the mineralogical composition and significantly affect clinker reactivity.

Therefore, the current recycling processes lack efficiency and fail to fully separate and recover valuable components from concrete waste, leading to incomplete recycling and significant amounts of waste that still require disposal. Consequently, most demolished concrete ends up in landfills or is downcycled for road-based materials.

The recycling of other industrial solid waste suffers from similar problems of inefficient and incomplete recovery. There is thus still a need to develop a process for recycling industrial solid waste that is efficient and eco-friendly.

### SUMMARY

The present disclosure provides an efficient and cost-effective process for treating and recycling calcium-silica-based industrial solid waste, transforming them into valuable materials that can be reused in the construction industry and chemical industry, which promotes sustainable practices and contributes to a circular economy.

By electrochemical-driven recycling, the calcium-silica-based industrial solid waste can be recovered into one or more of metal-rich substances, Si-rich substances, and recycled granules of different sizes. Taking concrete waste as an example, the recycled materials of metal-rich substances, Si-rich substances and recycled granules can be used in the manufacturing of reversed cement clinker and concrete. XRD data indicates that the reversed Portland cement has a mineral constitution similar to commercial Ordinary Portland Cement (OPC). The resulting reversed Portland Cement (RPC) has a similar hydraulic property to OPC. The reversed concrete (RC) fabricated from RPC, recycled granules and water could develop a strength of 44.7 MPa after 28 days normal hydration curing.

In a first aspect, provided herein is a process for treating calcium-silica-based industrial solid waste, the process comprises:
combining the calcium-silica-based industrial solid waste with an aqueous solution comprising a metal chelating agent and water thereby forming a solid waste suspension;
combining the solid waste suspension with an acid precursor thereby forming an electrolysis mixture;
subjecting the electrolysis mixture to electrolysis whereby the acid precursor is oxidized in situ thereby forming an acid and at least a portion of metal ions in the calcium-silica-based industrial solid waste are extracted into the water thereby forming a first mixture comprising a metal solution, comprising the at least a portion of metal ions and water, and a first residue;
separating the metal solution and the first residue; and
combining the metal solution with a solution comprising a first precipitator selected from the group consisting of an alkali metal citrate, citric acid and oxalic acid and optionally a surfactant thereby forming a suspension comprising metal.

In certain embodiments, the metal solution has a pH of 0.3-4.0.

In certain embodiments, the process further comprises:
combining the suspension comprising metal with a base produced in the electrolysis thereby forming a second mixture comprising a metal precipitate; and
separating the metal precipitate from the second mixture.

In certain embodiments, the second mixture has a pH>12.

In certain embodiments, the process further comprises:
combining the first residue with a surfactant thereby forming a first residue suspension;
combining the first residue suspension with a base produced in the electrolysis thereby forming a mixture comprising a second residue and a silica solution, and
separating the second residue and the silica solution.

In certain embodiments, the process further comprises:
combining the silica solution with a second precipitation solution comprising one or more of polyetherimide, chitosan, and tannic acid thereby forming a suspension comprising silica.

In certain embodiments, the process further comprises:
combining the suspension comprising silica with an acid produced in the electrolysis thereby forming a third mixture comprising a silica precipitate; and
separating the silica precipitate from the third mixture.

In certain embodiments, the third mixture has a pH of 4.0-7.5.

In certain embodiments, the process further comprises:
sieving the second residue to obtain granules with sizes ranging from 0.1 mm to 50 mm.

In certain embodiments, the process further comprises: the acid precursor comprises one or more of NaClO₄, NaNO₃, KClO₄ and KNO₃.

In certain embodiments, the weight ratio of the acid precursor to the calcium-silica-based industrial solid waste ranges from 0.05 to 1.0.

In certain embodiments, the chelating agent comprises one or more of ethylene diamine tetraacetic acid (EDTA), diethylenetriaminepentaacetic acid (DTPA), ethylene glycol tetraacetic acid (EGTA) and nitrilotriacetic acid (NTA).

In certain embodiments, the surfactant comprises an anionic surfactant, a cationic surfactant or a nonionic surfactant.

In certain embodiments, the industrial solid waste comprises one or more of concrete waste, incineration bottom ash, incineration fly ash, coal fly ash, steel slag and waste glass.

Advantageously, the process described herein achieves closed-loop material conversion and converts calcium-silica-based industrial solid waste into valuable materials with a closed-loop circularity index exceeding 90 wt %. This high efficiency is a significant improvement over conventional methods, which often have lower recovery rates. The recovered materials can be used as raw feedstock for producing reversed Portland and reversed concrete in construction industry, thus reducing the need for new natural resources. Moreover, they can also be used as raw material for chemicals production.

The process is also environmentally beneficial. The recycled and decarbonized substances are used in place of traditional raw materials (limestone and clay) for Portland cement production, significantly lowering emission of CO₂ associated with cement synthesis.

### BRIEF DESCRIPTION OF THE DRAWINGS

The foregoing aspects and many of the attendant advantages of this invention will become more readily appreciated and understood by reference to the following detailed description, when taken in conjunction with the accompanying drawing.

FIG. 1 depicts the flow of electrochemical-driven recycling process on concrete waste in accordance with certain embodiments described herein.

FIG. 2 depicts images of the resulted products of (a) metal-rich decarbonized substance, (b) Si-rich substance, (c) recycled granules (2.36-10 mm), (d) recycled granules (0.3-2.36 mm) and (e) recycled granules (0-0.3 mm).

FIG. 3 depicts optical images of (a) reversed Portland Cement (RPC) and (b) traditional Ordinary Portland Cement (OPC).

FIG. 4 shows compressive strength (MPa) on the 28th day after curing of RPC paste and OPC paste.

### DETAILED DESCRIPTION

### Definitions

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present disclosure and claims, unless the context requires otherwise, the word “include” or variations such as “includes” or “including”, will be understood to imply the inclusion of a stated integer or group of integers, but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

The terms “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The processes and compositions of the present disclosure may comprise, consist essentially of, or consist of the components and ingredients of the present disclosure as well as other ingredients described herein. As used herein, “consisting essentially of means that the methods and compositions may include additional steps, components or ingredients, but only if the additional steps, components or ingredients do not materially alter the basic and novel characteristics of the claimed processes and compositions.

The term “calcium-silica-based industrial solid waste” used herein refers to a range of materials discarded during industrial processes, containing calcium and/or silica. Exemplary calcium-silica-based industrial solid waste includes, but is not limited to, concrete waste, incineration bottom ash, incineration fly ash, coal fly ash, steel slag, waste glass or mixtures thereof.

The process disclosed herein transforms calcium-silica-based industrial solid waste, such as concrete waste, into valuable materials such as decarbonized metal-rich and Si-rich substances and reusable aggregates. These recycled components can replace natural resources in Portland Cement production and serve as complete substitutes for natural aggregates in concrete manufacturing.

From steel slag and fly ash, metal-rich substances and Si-rich substances can be recovered, respectively, and can be used as the raw materials in the production, such as silicate glass, catalyst support, filler materials, and flux agents, in the chemical industry.

Both “reversed Portland cement” and “reversed concrete”, as used herein, refer to reversed materials, that have undergone a process of reversing its original manufacturing, chemical, or structural formation. This process effectively transforms the materials back into their precursors, components, or another usable state, aligning with principles of recycling and circular economy.

“Reversed Portland cement” is the cementitious components that are extracted or recovered from concrete waste after undergoing a recycling process, in particular the electrochemical recycling process as described herein. Through the recycling process, the chemically transformed cement matrix in the waste is reverted to a usable form. The recovered cementitious components retain their ability to function as a cementitious binder for creating new cementitious materials, supporting sustainable construction practices.

“Reversed concrete” refers to a composite material that includes one or more components (such as cementitious materials, aggregates, and/or fine particles) have been separated and reverted to their original or reusable forms through a recycling process of concrete waste.

“Concrete” as used herein refers to construction materials produced from cement as the main cementitious material, while mixing water, sand and stone, if necessary, chemical additives and mineral additives, in appropriate proportions. Concrete mainly has two phases and states: the fresh state before curing and hardening, i.e., freshly mixed concrete or concrete mix; and the hard state after curing and hardening, i.e., hardened concrete or concrete. “Concrete waste” used herein refers to those produced in demolition of old buildings (structures), concrete production process, relocation of municipal works, pavement repair, major infrastructure renovation, engineering construction, as well as substandard concrete from commercial concrete plants and prefabricate plants.

Current processes for recycling calcium-silica-based industrial solid waste suffer from inefficiency and environmental problems. To address these problems, the present disclosure provides a novel electrochemical process to efficiently recycle calcium-silica-based industrial solid waste. The process described herein underscores the potential of an electrochemical process to create a nearly closed-loop system for solid waste recycling (with a circularity index exceeding 90 wt%), converting the solid waste into high-value products. The process not only enhances sustainability in industrial practices but also aligns with economic viability.

In the first aspect, the present disclosure provides a process for treating calcium-silica-based industrial solid waste, the process comprises:
combining the calcium-silica-based industrial solid waste with an aqueous solution comprising a metal chelating agent and water thereby forming a solid waste suspension;
combining the solid waste suspension with an acid precursor thereby forming an electrolysis mixture;
subjecting the electrolysis mixture to electrolysis whereby the acid precursor is oxidized in situ thereby forming an acid and at least a portion of metal ions in the calcium-silica-based industrial solid wastes are extracted into the water thereby forming a first mixture comprising a metal solution, comprising the at least a portion of metal ions and water, and a first residue;
separating the metal solution and the first residue; and combining the metal solution with a solution comprising a first precipitator selected from the group consisting of an alkali metal citrate, citric acid and oxalic acid, and optionally a surfactant, thereby forming a suspension comprising metal.

In certain embodiments, the calcium-silica-based industrial solid waste comprises one or more of concrete waste, incineration bottom ash, incineration fly ash, coal fly ash, steel slag and waste glass.

In certain embodiments, the chelating agent comprises one or more of ethylene diamine tetra acetic acid (EDTA), diethylenetriaminepentaacetic acid (DTPA), ethylene glycol tetraacetic acid (EGTA), and nitrilotriacetic acid (NTA). The chelating agent can be useful in improving the extraction of metal ions from the calcium-silica-based industrial solid waste.

In certain embodiments, the metal chelating agent has a concentration of 0.1-3.0 wt % or 0.1-1.0 wt % in the aqueous solution. In certain embodiments, the chelating agent has a concentration of 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, or any value ranges therebetween in the aqueous solution.

In certain embodiments, the calcium-silica-based industrial solid waste can be contacted with the aqueous solution comprising the chelating agent for 2 -12 hours, such as 2 hours, 3 hours, 4 hours, 5 hours, 6 hours, 7 hours, 8 hours, 9 hours, 10 hours, 11 hours, or 12 hours, or any value ranges therebetween.

In certain embodiments, the acid precursor comprises one or more alkali metal salts of nitrate, perchlorate. For example, the acid precursor may comprise one or more of NaClO4, NaNO₃, KClO₄, and KNO₃.

In certain embodiments, the weight ratio of the acid precursor to the calcium-silica-based industrial solid waste ranges from 0.05 to 1.0, such as 0.05 to 0.5 or 0.05 to 0.1. In certain embodiments, the weight ratio of the acid precursor to the calcium-silica-based industrial solid waste ranges from 0.05, 0.06, 0.07, 0.08, 0.09, 0.10, 0.11, 0.12, 0.13, 0.14, 0.15, 0.16, 0.17, 0.18, 0.19, 0.20, 0.25, 0.30, 0.35, 0.40, 0.45, 0.50, 0.55, 0.60, 0.65, 0.70, 0.75, 0.80, 0.85, 0.90, 0.95 and 1.0, or any value ranges therebetween.

In certain embodiments, the acid precursor has a concentration of 0.1-5.0 mol/L, 0.1-3.0 mol/L or 0.5-5.0 mol/L. In certain embodiments, the electrolyte has a concentration of 0.1 mol/L, 0.2 mol/L, 0.3 mol/L, 0.4 mol/L, 0.5 mol/L, 0.6 mol/L, 0.7 mol/L, 0.8 mol/L, 0.9 mol/L, 1.0 mol/L, 1.1 mol/L, 1.2 mol/L, 1.3 mol/L, 1.4 mol/L, 1.5 mol/L, 1.6 mol/L, 1.7 mol/L, 1.8 mol/L, 1.9 mol/L, 2.0 mol/L, 2.1 mol/L, 2.2 mol/L, 2.3 mol/L, 2.4 mol/L, 2.5 mol/L, 2.6 mol/L, 2.7 mol/L, 2.8 mol/L, 2.9 mol/L, 3.0 mol/L, 3.2 mol/L, 3.5 mol/L, 3.8 mol/L, 4.0 mol/L, 4.2 mol/L, 4.5 mol/L, 4.8 mol/L or 5.0 mol/L, or any value ranges therebetween.

In certain embodiments, the electrolysis mixture is subjected to electrolysis for 1-18 hours, preferably 1-10 hours or 1-5 hours, depending on the desired leaching efficiency and the amount of calcium-silica-based industrial solid waste. In certain embodiments, the acid extraction continues for 1 hour, 2 hours, 3 hours, 4 hours, 5 hours, 6 hours, 7 hours, 8 hours, 10 hours, 11 hours, 12 hours, 13 hours, 14 hours, 15 hours, 16 hours, 17 hours, 18 hours or any value ranges therebetween. In certain embodiments, the electrolysis is conducted at room temperature.

In certain embodiments, the metal solution has a final pH of 0.3-4.0 to facilitate the leaching of metal ions. In certain embodiments, the metal solution has a pH of 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9 or 4.0 or any value ranges therebetween.

In the electrolysis process, the electrode materials are not particularly limited and can be those conventionally used in an electrolysis process. In certain embodiments, the cathode material comprises platinum, nickel, copper or stainless steel. In certain embodiments, the anode material comprises platinum, aluminium, tin or lead.

In certain embodiments, the electrolysis process utilizes an H-type electrolytic cell, which is composed of two separate compartments connected via a filter or an ion-exchange membrane, such as a cation exchange membrane, an anion exchange membrane, or a bipolar membrane. These compartments house the anolyte and catholyte solutions, which may include a variety of electrolytes tailored to the specific electrochemical reactions. The applied voltage in electrolysis process ranges from 1.5 V- 36 V, depending on the desired electrolysis efficiency and the amount of calcium-silica-based industrial solid wastes.

After treating the calcium-silica-based industrial solid waste with a chelating agent and an acid, the resulting mixture may be separated to obtain a metal solution and a first residue. The separation described in this and the following processes can be performed by conventional means, such as centrifugation, filtration, decanting, and any other means for separating a suspension.

In certain embodiments, the process in the first aspect further comprises:
combining the suspension comprising the metal with a base produced in the electrolysis thereby forming a second mixture comprising a metal precipitate; and
separating the metal precipitate from the second mixture.

In certain embodiments, the first precipitator has a concentration in the solution of 0.1-3.0 wt %, or 0.1-1.0 wt %, for example, 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, or any value ranges therebetween.

In certain embodiments, the surfactant comprises an anionic surfactant, a cationic surfactant or a nonionic surfactant. In certain embodiments, the surfactant comprises sodium dodecyl sulfate (SDS), cetyl trimethyl ammonium bromide (CTAB) and Triton® X-100, as well as phosphonate-based surfactants. In certain embodiments, the surfactant is an alkali-resistant surfactant.

In certain embodiments, the surfactant may have a concentration in the solution of 0 -3.0 wt %, or 0.1-1.0 wt %. In certain embodiments, the surfactant has a concentration of 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, or any value ranges therebetween.

In certain embodiments, the pH of second mixture is (or modified to be) >12.0, which results in the precipitation of at least a portion of the metal ions from the solution. In certain embodiments, substantially all of the metal ions are precipitated from the solution. For example, the second mixture has a pH of 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9 or 14.0, or any value ranges therebetween.

In certain embodiments, the metal precipitate comprises metal hydroxides, such as the major component of calcium hydroxide, and minor components of aluminium hydroxide, iron hydroxide or their combinations thereof.

In certain embodiments, the metal-containing substance (metal precipitate) is inherently decarburized in the process disclosed herein. The process itself in the present disclosure facilitates the removal of carbonates during the formation of the desired products, eliminating the need for a separate decarbonization step. This integrated process enhances efficiency and simplifies the overall recycling process.

In certain embodiments, the process in the first aspect further comprises:
combining the first residue with a surfactant thereby forming a first residue suspension;
combining the first residue suspension with a base produced in the electrolysis thereby forming a mixture comprising the second residue and a silica solution; and
separating the second residue and the silica solution.

The surfactant used to treat the first residue may comprise sodium dodecyl sulfate (SDS), cetyl trimethyl ammonium bromide (CTAB), Triton® X-100, or a phosphonate-based surfactant, such as alkyl phosphonate.

The first residue can be treated with the surfactant for 1-5 hours, preferably 2-3 hours. In certain embodiments, the first residue can be treated with the surfactant for 1 hour, 2 hours, 3 hours, 4 hours, 5 hours or any value ranges therebetween.

After treating with the surfactant, the resulting first residue is further washed with the base, for example at a temperature of 60-90° C. for 3-36 hours, and the resulting suspension is separated to obtain a silica solution and the second residue.

In certain embodiments, the second residue comprises aggregate material recycled from the calcium-silica-based industrial solid waste. The size of the aggregate may vary depending on the characteristics and initial dimensions of the processed solid waste.

In certain embodiments, the process in the first aspect further comprises combining the silica solution with a second precipitator solution comprising polyetherimide, chitosan, and tannic acid, thereby forming a suspension comprising silica.

In certain embodiments, the second precipitator has a concentration of 0.1-3.0 wt % or 0.1-1.0 wt %. In certain embodiments, the second precipitant has a concentration of 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, or any value ranges therebetween.

In certain embodiments, the process in the first aspect further comprises combining the suspension comprising silica with an acid produced in the electrolysis thereby forming a third mixture comprising a silica precipitate; and then separating the silica precipitate from the third mixture.

In certain embodiments, the third mixture has a pH of 4.0-7.5. In certain embodiments, the third mixture has a pH of 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4 or 7.5, or any value ranges therebetween.

In certain embodiments, after treatment with a second precipitation solution, the resulting suspension is agitated at 50 -250 rpm for 6-24 hours, followed by an aging period of 24-48 hours to form a flocculent precipitate, which is then filtered, washed and dried to produce the silica precipitate.

In certain embodiments, the silica precipitate comprises silicon dioxide (SiO₂).

In certain embodiments, the second residue is washed with water to obtain surface clean granules. The granules are then sieved into various size ranges, including 0.1 mm to 50 mm, such as 0.1-0.3 mm, 0.3-2.36 mm, 2.36-10 mm, and 10mm- 50 mm, making them suitable for different applications.

According to the process described herein, all the liquid waste may be collected and purified through reverse osmosis for reutilization.

In the second aspect, the present disclosure also provides a reversed Portland cement formed by recycled metal-containing substance and recycled Si-containing substance, wherein the recycled metal-containing substance can be the metal precipitate recycled from the processes described above; and/or the recycled Si-containing substance can be the silica precipitate recycled from the processes described above.

In certain embodiments, the reversed Portland cement is formed by mixing the recycled metal-containing substance and recycled Si-containing substance, and then calcining the mixture at a temperature ranging from 1400-1500° C. for 20-60 minutes, followed by a rapid cooling process to ambient temperature with the cooling rate larger than 100° C./min.

In the third aspect, the present disclosure also provides a reversed concrete produced from reversed Portland cement in the second aspect.

In certain embodiments, the reversed concrete produced by blending the reversed Portland cement above with the recycled granules and water.

### EXAMPLES

Embodiments of the present disclosure are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the claims.

In the following section, the process for treating calcium-silica-based industrial solid waste is described in detail by taking concrete waste as a raw material. In the Examples, a Rigaku Smart-Lab 9kW X-ray diffractometer was used to determine the crystal phase of the product; and the compressive strength of the product was determined by a servo-hydraulic compression testing machine (WANCE HCT106A).

### Recycling Process on Concrete Waste

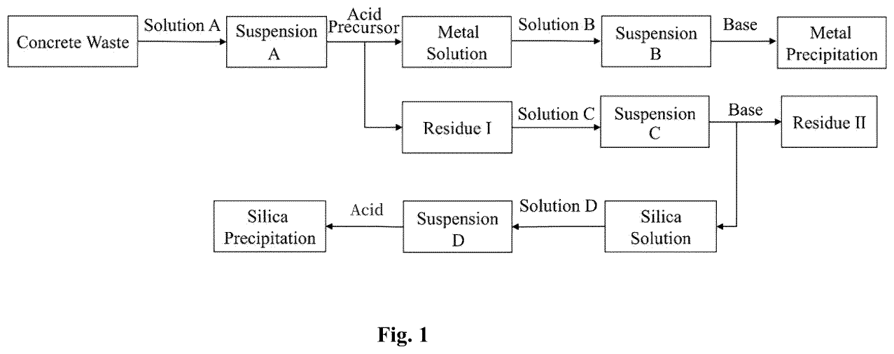

FIG. 1 depicts the flow of the recycling process on concrete waste.

In Step (a), 50 g of the concrete waste was crushed and pulverized into gravels with an average diameter of 1-10 mm. To treat the surface of the gravels, an aqueous solution A was prepared to comprise the chelating agent of EDTA with a concentration of 1.0 wt %. Then, the gravels were immersed in such a solution A for 5-8 hours to obtain a suspension A.

1.0 mol/L of the acid precursor NaNO₃ was introduced into above suspension A to form an electrolysis mixture to wash the gravels. Then the electrolysis mixture was subjected to electrolysis in an H-type electrolytic cell under a voltage of 36 V, whereby the acid precursor is oxidized in situ forming an acid and at least a portion of metal ions in the concrete waste gravels are extracted into the water thereby forming a first mixture comprising a metal solution comprising the at least a portion of metal ions and water and a first residue. The electrochemical process simultaneously produced a base solution for subsequent use.

The metal solution was adjusted within a pH range of 0.3-4 to accomplish the leaching of metal ions and separate residual cement pastes from the aggregate surfaces. The electrolysis mixture is subjected to electrolysis for 3-5 hours at room temperature, depending on the desired leaching efficiency and the amount of concrete waste. After such surface treatment, the resulting mixture was filtered to obtain a metal solution and the first residue.

In Step (b), to precipitate the metal ions in the metal solution, an aqueous solution B containing the first precipitator of sodium citrate and surfactant of Triton X-100 were prepared. The concentration for the precipitator was 1.0 wt %, and for the surfactant was 1.0 wt %. After precipitation, a suspension B containing solid materials were formed.

To further precipitate the remaining metal ions from suspension B, it was combined with the base solution above to obtain the second mixture. The final pH of the second mixture was adjusted to above 12.5 to facilitate the formation of a metal precipitation (recycled metal-containing substance), which was then separated from the second mixture.

In Step (c), the first residue was immersed in a solution C containing the surfactant of Triton X-100 with a concentration of 1.0 wt % for 2 h to obtain the suspension C. Then the suspension C was combined with the base solution to wash the surface of the first residue, at a temperature of 60-90° C. for 3-36 hours. The pH of the base solution is controlled between 10.75 and 12.0. The specific time of surface treatment depends on the amount of the first residue and the pH of the base solution. After this surface treatment, the resulting mixture was filtered to obtain the silica solution and the second residue. The second residue was sieved to obtain recycled granules with different sizes of 0.1-0.3 mm, 0.3-2.36 mm, and 2.36-10 mm.

In Step (d), a solution D containing 1.0 wt % of the second precipitator of polyetherimide was added into the silica solution and allowed to stand for 6-10 hours at room temperature to form a suspension D comprising silica.

The suspension D was further combined with the acid produced in the electrolysis process and to complete the silica precipitation. The resulting third mixture was at a final pH of 6.0 to 7.0, agitated at 50 -250 rpm for 6-24 hours, followed by subjected to an aging period of 24-48 hours to form a flocculent precipitate, which was then filtered, washed, and dried to obtain the silica precipitation (recycled Si-containing substance).

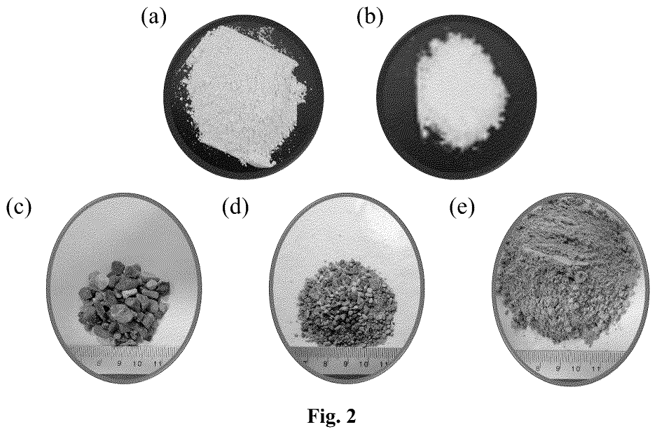

FIG. 2 depicts images of the resulting products of (a) metal-rich substance, (b) Si-rich substance, (c) recycled granules (2.36-10 mm), (d) recycled granules (0.3-2.36 mm) and (e) recycled granules (0-0.3 mm).

### Production of RPC

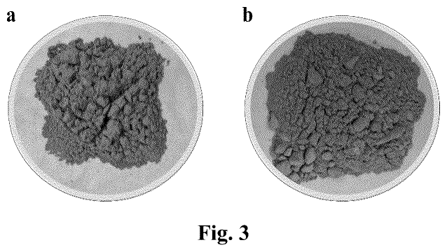

The recycled metal-containing substances and recycled Si-containing substances obtained from the recycling process shown in FIG. 1 were used exclusively as raw feedstocks for the production of reversed Portland Cement clinker.
Step I: The recycled metal-containing and Si-containing substances were combined at a mass ratio of 88.15:11.85, determined based on oxide composition and loss on ignition analysis, and blended homogeneously using a V-shaped blender. The blending process was carried out for at least 15 minutes to ensure uniform distribution of all components.
Step II: The homogenized raw materials were transferred to a ceramic crucible and placed in a muffle furnace (e.g., Carbolite BLF1700). The material was heated at a controlled rate of 5° C./min to reach a target temperature of 1450° C. The temperature was maintained at 1450° C. for 30 minutes to facilitate the formation of the reversed Portland Cement clinker. After the sintering process, the material was rapidly cooled to room temperature to preserve the alite phase and prevent decomposition. Cooling was achieved by quenching the crucible in air or placing it on a metal plate to ensure efficient heat dissipation. The clinkering parameters for synthesizing clinker were defined based on the raw feedstock composition. The lime saturation factor (LSF) was set at 99.48, the silica modulus (SM) at 2.04, and the aluminium ratio (AR) at 0.84 to achieve the desired phase composition and material performance.
Step III: The cooled clinker was ground using an agate bowl mill to achieve a fine powder with a particle size of less than 75 μm. This particle size ensures optimal reactivity and performance in cementitious applications.
Step IV: To produce the final RPC, 5 wt % gypsum was added to the ground clinker. The clinker and gypsum were thoroughly mixed for at least 5 minutes to achieve uniform blending. The finished RPC was stored in airtight containers to prevent moisture absorption and preserve quality. FIG. 3 depicts optical images of (a) reversed Portland cement (RPC) and (b) traditional Ordinary Portland Cement (OPC). As can be seen, the RPC obtained in this Example is resemblant in appearance to the OPC.

Table 1 shows the Rietveld refinement results of XRD patterns for RPC and OPC (wt %), which shows the mineral constitution for the produced RPC and conventional OPC.

TABLE 1

| | | | Tricalcium | Brown- | | | Amor- |
|---|---|---|---|---|---|---|---|
| | Alite | Belite | aluminate | millerite | Gypsum | Lime | phous |
| RPC | 48.1 | 32.4 | 2.6 | 4.5 | 5.0 | 0.6 | 6.8 |
| OPC | 49.4 | 30.0 | 4.4 | 4.7 | 5.0 | — | 6.6 |

The RPC product has the similar constitution as that of OPC, while comprises slightly higher content of belite, lime and amorphous, and lower content of alite, tricalcium aluminate and brownmillerite.

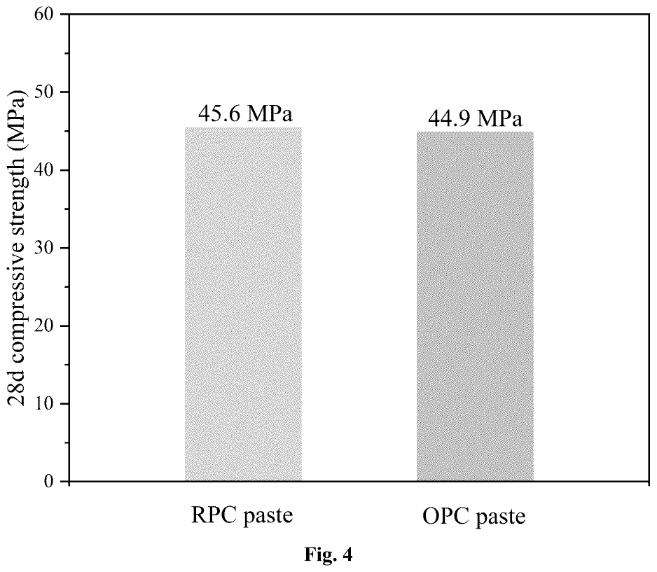

FIG. 4 shows compressive strength (MPa) on the 28th day after curing of RPC paste and OPC paste. As shown, the 28th day compressive strength for cured RPC is 45.6 MPa, which is higher than that for the cured OPC, 44.9 MPa. It indicates that the prepared RPC has even higher compressive strength than the conventional OPC.

### Production of RC

### 1. Materials Preparation

To fabricate Reversed Concrete (RC), two key components were prepared: Reversed Portland Cement (RPC) and Electrochemical-Recycled Granules (ERG). RPC was obtained from previously treated concrete waste using the specified recycling process. ERG, the second residue collected during the same recycling process, was subjected to water washing followed by drying, reducing its moisture content to below 0.5%. For comparison purposes, a natural resources-based concrete (N—C) was also fabricated using ordinary Portland cement (OPC) and natural aggregates.

### 2. Concrete Mixture Proportioning

The components for concrete were proportioned according to the mix design specified in Table 2. Each material was weighed accurately, and the water-to-cement ratio was verified to ensure consistency. Water content was adjusted based on the moisture state of the aggregates to maintain uniformity.

TABLE 2

| | | | Fine aggregate: | Coarse aggregate: | |
|---|---|---|---|---|---|
| | OPC | RPC | 0.3-2.36 mm | 2.36-10 mm | Water |
| | (kg) | (kg) | (kg) | (kg) | (kg) |
| N-C | 410 | — | 636 | 1131 | 164 |
| | | | (Using standard sand) | (Using natural aggregate) | |
| RC | — | 410 | 636 | 1131 | |
| | | | (Using ERG) | (Using ERG) | |

### 3. Mixing Process:

Aggregates and cement were added to a concrete mixer and mixed at a low speed for 1-2 minutes to homogenize the dry components. Water was then gradually introduced while mixing continued. Finally, the mixer speed was increased, and the mixture was stirred for an additional 3-5 minutes until a uniform consistency was achieved, ensuring no segregation or bleeding.

### 4. Casting and Molding

Concrete cubes were cast using molds with internal dimensions of 40 mm×40 mm×40 mm. A mold release agent was applied to facilitate demolding. The molds were filled in three layers, with each layer compacted using a tamping rod or vibration table. The top surface of each cube was leveled using a straightedge or trowel.

### 5. Curing

The specimens were demolded after 24 hours and cured under standard conditions, specifically in water at 25° C.±2° C. for 28 days.

### 6. Performance Comparison

The RC, composed of RPC and ERG, achieved a 28-day compressive strength of 44.7 MPa, satisfying the relevant strength criteria of structural concrete. For reference, the N—C exhibited a comparable compressive strength of 46.9 MPa.

The disclosed experimental data was designed to establish the feasibility and reproducibility of the claimed process under representative conditions. The chosen materials and process parameters reflect the desired outcomes and are aligned with standard practices in the field. The focus of the current disclosure was to demonstrate the viability of the process under the specific conditions described. While the experimental data provided focuses on specific conditions, the process is not intended to be limited to these embodiments. The methodology described herein is adaptable to a range of conditions, and variations in electrolytes, precipitants, and surfactants could be explored to optimize the process for specific applications. The selection of the described parameters was based on their practical relevance and alignment with the objectives of this invention.

What is claimed is:

1. A process for treating calcium-silica-based industrial solid waste, wherein the process comprises:
combining the calcium-silica-based industrial solid waste with an aqueous solution comprising a metal chelating agent and water thereby forming a solid waste suspension;
combining the solid waste suspension with an acid precursor thereby forming an electrolysis mixture;
subjecting the electrolysis mixture to electrolysis whereby the acid precursor is oxidized in situ thereby forming an acid and at least a portion of metal ions in the calcium-silica-based industrial solid waste are extracted into the water thereby forming a first mixture comprising a metal solution comprising the at least a portion of metal ions and water and a first residue;
separating the metal solution and the first residue; and
combining the metal solution with a solution comprising a first precipitator selected from the group consisting of an alkali metal citrate, citric acid and oxalic acid and optionally a surfactant thereby forming a suspension comprising metal.

2. The process according to claim 1, wherein the metal solution has a pH of 0.3-4.0.

3. The process according to claim 1, further comprising:
combining the suspension comprising metal with a base produced in the electrolysis thereby forming a second mixture comprising a metal precipitate; and
separating the metal precipitate from the second mixture.

4. The process according to claim 3, wherein the second mixture has a pH>12.

5. The process according to claim 1, further comprising:
combining the first residue with a surfactant thereby forming a first residue suspension;
combining the first residue suspension with a base produced in the electrolysis thereby forming a mixture comprising a second residue and a silica solution; and
separating the second residue and the silica solution.

6. The process according to claim 5, further comprising: combining the silica solution with a second precipitation solution comprising one or more of polyetherimide, chitosan, and tannic acid thereby forming a suspension comprising silica.

7. The process according to claim 6, further comprising:
combining the suspension comprising silica with an acid produced in the electrolysis thereby forming a third mixture comprising silica precipitate; and
separating the silica precipitate from the third mixture.

8. The process according to claim 7, wherein the third mixture has a pH of 4.0-7.5.

9. The process according to claim 5, further comprising sieving the second residue to obtain granules with sizes ranging from 0.1 mm to 50 mm.

10. The process according to claim 1, wherein the acid precursor comprises one or more of NaClO₄, NaNO₃, KClO₄ and KNO₃.

11. The process according to claim 1, wherein the weight ratio of acid precursor to the calcium-silica-based industrial solid waste ranges from 0.05 to 1.0.

12. The process according to claim 1, wherein the chelating agent comprises one or more of ethylene diamine tetraacetic acid (EDTA), diethylenetriaminepentaacetic acid (DTPA), ethylene glycol tetraacetic acid (EGTA) and nitrilotriacetic acid (NTA).

13. The process according to claim 1, wherein the surfactant comprises an anionic surfactant, a cationic surfactant or a nonionic surfactant.

14. The process according to claim 1, wherein the industrial solid waste comprises one or more of concrete waste, incineration bottom ash, incineration fly ash, coal fly ash, steel slag and waste glass.
